(19) United States
(12) Patent Application Publication
(10) Pub. No.: US 2025/0212211 A1
(43) Pub. Date: Jun. 26, 2025

(54) DEVICES, METHODS, APPARATUSES, AND COMPUTER READABLE MEDIA FOR DYNAMICALLY ADJUSTING REPETITION FACTOR

(71) Applicant: Nokia Technologies Oy, Espoo (FI)

(72) Inventors: Alessio MARCONE, Munich (DE); Jing Yuan SUN, Beijing (CN); Mads LAURIDSEN, Aalborg (DK); Frank FREDERIKSEN, Aalborg (DK); Amir Mehdi AHMADIAN TEHRANI, Munich (DE)

(21) Appl. No.: 18/849,749

(22) PCT Filed: Apr. 29, 2022
(86) PCT No.: PCT/CN2022/090139

§ 371 Date: Sep. 23, 2024

(51) Int. Cl. H04W 72/1268; H04L 1/08

(52) U.S. Cl. CPC H04W 72/1268; H04L 1/08

(57) ABSTRACT

Disclosed are devices, methods, apparatuses, and computer readable media for dynamically adjusting repetition factor. An example terminal device may include at least one processor and at least one memory. The at least one memory may include computer program code, and the at least one memory and the computer program code may be configured to, with the at least one processor, cause the terminal device to perform: receiving, from a network device, a configuration for transmission of an uplink channel, the configuration comprising a repetition factor set and at least one parameter for determining a repetition factor from the repetition factor set; determining the repetition factor from the repetition factor set based on the at least one parameter; and performing the transmission of the uplink channel according to the determined repetition factor.

### TECHNICAL FIELD

Various embodiments relate to devices, methods, apparatuses, and computer readable media for dynamically adjusting repetition factor.

### BACKGROUND

Uplink (UL) channel is used for a user equipment (UE) to transmit information to network side. Physical uplink control channel (PUCCH) is a kind of UL channel used by a UE for conveying control information through uplink control information (UCI). A repetition factor is introduced to indicate a number of repetitions for transmitting an UL channel. Channel condition, for example, pathloss may be taken into account in configuring the repetition factor. Differently than in a terrestrial network (TN), in a non-terrestrial network (NTN), the channel condition may change rapidly and in a semi-predictive manner. Therefore, a repetition factor for unscheduled UL channel resources, e.g. the PUCCH resources for periodic channel state information (CSI) reporting, may become obsolete in a short time. For example, when a satellite is located exactly above the UE, a small repetition factor may be sufficient for the periodic CSI reporting on PUCCH. However, this repetition factor may become too small when the satellite approaches horizon even if the UE does not move, which may eventually impact CSI reporting and performance.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may include computer program code, and the at least one memory and the computer program code may be configured to, with the at least one processor, cause the terminal device to perform: receiving, from a network device, a configuration for transmission of an uplink channel, the configuration comprising a repetition factor set and at least one parameter for determining a repetition factor from the repetition factor set; determining the repetition factor from the repetition factor set based on the at least one parameter; and performing the transmission of the uplink channel according to the determined repetition factor.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing, and the repetition factor may be determined based on the initial timing, a current timing and the at least one duration value.

In some example embodiments, the initial timing and the current timing may be in terms of system frame number.

In some example embodiments, the at least one parameter may comprise a mapping between the repetition factor set and at least one distance value between the terminal device and the network device, and the repetition factor may be determined based on a distance value between the terminal device and the network device.

In some example embodiments, the at least one parameter may comprise a mapping between the repetition factor set and at least one elevation angle value of the network device relative to the terminal device, and the repetition factor may be determined based on an elevation angle value of the network device relative to the terminal device.

In some example embodiments, the configuration may be received via a radio resource control signaling or a system information block.

In some example embodiments, the configuration may be specific to the terminal device or specific to a cell the terminal device is associated with.

In some example embodiments, the uplink channel may be at least one of the following: physical uplink control channel, physical uplink shared channel, physical random access channel, and sounding reference signal.

In a second aspect, disclosed is a network device. The network device may include at least one processor and at least one memory. The at least one memory may include computer program code, and the at least one memory and the computer program code may be configured to, with the at least one processor, cause the network device to perform: determining a configuration for transmission of an uplink channel, the configuration comprising a repetition factor set and at least one parameter for determining a repetition factor from the repetition factor set; and transmitting, to a terminal device, the configuration.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing in terms of system frame number.

In some example embodiments, the at least one parameter may comprise a mapping between the repetition factor set and at least one distance value between the terminal device and the network device.

In some example embodiments, the at least one parameter may comprise a mapping between the repetition factor set and at least one elevation angle value of the network device relative to the terminal device.

In some example embodiments, the configuration may be transmitted via a radio resource control signaling or a system information block.

In some example embodiments, the configuration may be specific to the terminal device or specific to a cell the terminal device is associated with.

In a third aspect, disclosed is a method performed by a terminal device. The method may comprise: receiving, from a network device, a configuration for transmission of an uplink channel, the configuration comprising a repetition factor set and at least one parameter for determining a repetition factor from the repetition factor set; determining the repetition factor from the repetition factor set based on the at least one parameter; and performing the transmission of the uplink channel according to the determined repetition factor.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing, and the repetition factor may be determined based on the initial timing, a current timing and the at least one duration value.

In some example embodiments, the initial timing and the current timing may be in terms of system frame number.

In some example embodiments, the at least one parameter may comprise a mapping between the repetition factor set and at least one distance value between the terminal device and the network device, and the repetition factor may be determined based on a distance value between the terminal device and the network device.

In some example embodiments, the at least one parameter may comprise a mapping between the repetition factor set and at least one elevation angle value of the network device relative to the terminal device, and the repetition factor may be determined based on an elevation angle value of the network device relative to the terminal device.

In some example embodiments, the configuration may be received via a radio resource control signaling or a system information block.

In some example embodiments, the configuration may be specific to the terminal device or specific to a cell the terminal device is associated with.

In some example embodiments, the uplink channel may be at least one of the following: physical uplink control channel, physical uplink shared channel, physical random access channel, and sounding reference signal.

In a fourth aspect, disclosed is a method performed by a network device. The method may comprise: determining a configuration for transmission of an uplink channel, the configuration comprising a repetition factor set and at least one parameter for determining a repetition factor from the repetition factor set; and transmitting, to a terminal device, the configuration.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing in terms of system frame number.

In some example embodiments, the at least one parameter may comprise a mapping between the repetition factor set and at least one distance value between the terminal device and the network device.

In some example embodiments, the at least one parameter may comprise a mapping between the repetition factor set and at least one elevation angle value of the network device relative to the terminal device.

In some example embodiments, the configuration may be transmitted via a radio resource control signaling or a system information block.

In some example embodiments, the configuration may be specific to the terminal device or specific to a cell the terminal device is associated with.

In a fifth aspect, disclosed is an apparatus. The apparatus as a terminal device may comprise: means for receiving, from a network device, a configuration for transmission of an uplink channel, the configuration comprising a repetition factor set and at least one parameter for determining a repetition factor from the repetition factor set; means for determining the repetition factor from the repetition factor set based on the at least one parameter; and means for performing the transmission of the uplink channel according to the determined repetition factor.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing, and the repetition factor may be determined based on the initial timing, a current timing and the at least one duration value.

In some example embodiments, the initial timing and the current timing may be in terms of system frame number.

In some example embodiments, the at least one parameter may comprise a mapping between the repetition factor set and at least one distance value between the terminal device and the network device, and the repetition factor may be determined based on a distance value between the terminal device and the network device.

In some example embodiments, the at least one parameter may comprise a mapping between the repetition factor set and at least one elevation angle value of the network device relative to the terminal device, and the repetition factor may be determined based on an elevation angle value of the network device relative to the terminal device.

In some example embodiments, the configuration may be received via a radio resource control signaling or a system information block.

In some example embodiments, the configuration may be specific to the terminal device or specific to a cell the terminal device is associated with.

In some example embodiments, the uplink channel may be at least one of the following: physical uplink control channel, physical uplink shared channel, physical random access channel, and sounding reference signal.

In a sixth aspect, disclosed is an apparatus. The apparatus as a network device may comprise: means for determining a configuration for transmission of an uplink channel, the configuration comprising a repetition factor set and at least one parameter for determining a repetition factor from the repetition factor set; and means for transmitting, to a terminal device, the configuration.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing in terms of system frame number.

In some example embodiments, the at least one parameter may comprise a mapping between the repetition factor set and at least one distance value between the terminal device and the network device.

In some example embodiments, the at least one parameter may comprise a mapping between the repetition factor set and at least one elevation angle value of the network device relative to the terminal device.

In some example embodiments, the configuration may be transmitted via a radio resource control signaling or a system information block.

In some example embodiments, the configuration may be specific to the terminal device or specific to a cell the terminal device is associated with.

In a seventh aspect, a computer readable medium is disclosed. The computer readable medium may include instructions stored thereon for causing a terminal device to perform: receiving, from a network device, a configuration for transmission of an uplink channel, the configuration comprising a repetition factor set and at least one parameter for determining a repetition factor from the repetition factor set; determining the repetition factor from the repetition factor set based on the at least one parameter; and performing the transmission of the uplink channel according to the determined repetition factor.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing, and the repetition factor may be determined based on the initial timing, a current timing and the at least one duration value.

In some example embodiments, the initial timing and the current timing may be in terms of system frame number.

In some example embodiments, the at least one parameter may comprise a mapping between the repetition factor set and at least one distance value between the terminal device and the network device, and the repetition factor may be determined based on a distance value between the terminal device and the network device.

In some example embodiments, the at least one parameter may comprise a mapping between the repetition factor set and at least one elevation angle value of the network device relative to the terminal device, and the repetition factor may be determined based on an elevation angle value of the network device relative to the terminal device.

In some example embodiments, the configuration may be received via a radio resource control signaling or a system information block.

In some example embodiments, the configuration may be specific to the terminal device or specific to a cell the terminal device is associated with.

In some example embodiments, the uplink channel may be at least one of the following: physical uplink control channel, physical uplink shared channel, physical random access channel, and sounding reference signal.

In an eighth aspect, a computer readable medium is disclosed. The computer readable medium may include instructions stored thereon for causing a network device to perform: determining a configuration for transmission of an uplink channel, the configuration comprising a repetition factor set and at least one parameter for determining a repetition factor from the repetition factor set; and transmitting, to a terminal device, the configuration.

In some example embodiments, the at least one parameter may comprise at least one duration value.

In some example embodiments, the at least one duration value may be in terms of system frame number.

In some example embodiments, the at least one duration value may be one duration value corresponding to the repetition factor set.

In some example embodiments, the at least one duration value may be a vector of duration values associated with the repetition factor set.

In some example embodiments, the repetition factor set may be a vector of repetition factors.

In some example embodiments, the repetition factor set may comprise a single repetition factor.

In some example embodiments, the at least one parameter may further comprise an initial timing in terms of system frame number.

In some example embodiments, the at least one parameter may comprise a mapping between the repetition factor set and at least one distance value between the terminal device and the network device.

In some example embodiments, the at least one parameter may comprise a mapping between the repetition factor set and at least one elevation angle value of the network device relative to the terminal device.

In some example embodiments, the configuration may be transmitted via a radio resource control signaling or a system information block.

In some example embodiments, the configuration may be specific to the terminal device or specific to a cell the terminal device is associated with.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for dynamically adjusting repetition factor according to the example embodiments of the present disclosure.

FIG. 2 shows a flow chart illustrating an example method 200 for dynamically adjusting repetition factor according to the example embodiments of the present disclosure.

FIG. 3 shows a flow chart illustrating an example method 300 for dynamically adjusting repetition factor according to the example embodiments of the present disclosure.

FIG. 4 shows a block diagram illustrating an example device 400 for dynamically adjusting repetition factor according to the example embodiments of the present disclosure.

FIG. 5 shows a block diagram illustrating an example device 500 for dynamically adjusting repetition factor according to the example embodiments of the present disclosure.

FIG. 6 shows a block diagram illustrating an example apparatus 600 for dynamically adjusting repetition factor according to the example embodiments of the present disclosure.

FIG. 7 shows a block diagram illustrating an example apparatus 700 for dynamically adjusting repetition factor according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for dynamically adjusting repetition factor for unscheduled UL channel resources in a communication network where channel conditions change over time even for static UEs.

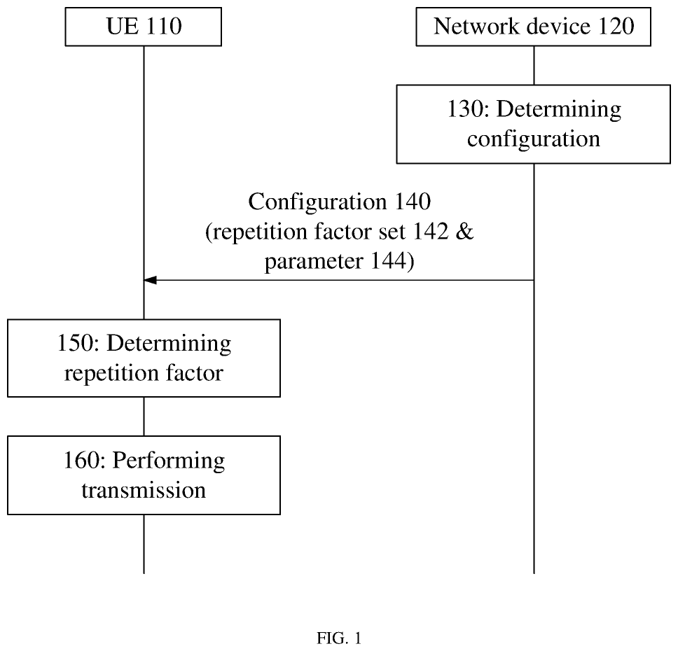

FIG. 1 shows an exemplary sequence diagram for dynamically adjusting repetition factor according to the example embodiments of the present disclosure. Referring to the FIG. 1, a UE 110 may represent any terminal device in a wireless communication network. A network device 120 may function as a BS in the wireless communication network and serving the UE 110. The wireless communication network may be e.g. a NTN, and the network device 120 may be located in a satellite.

In an operation 130, the network device 120 may determine a configuration 140 for transmission of an UL channel. In an embodiment, the configuration 140 may comprise a repetition factor set 142 and at least one parameter 144 for determining a repetition factor from the repetition factor set 142. The repetition factor in the repetition factor set 142 may be a repetition number for the UE 110 to transmit the UL channel and may be indicated as e.g. nrOfSlots.

Then, the network device 120 may transmit the configuration 140 to the UE 110. In an embodiment, the configuration 140 may be transmitted via a radio resource control (RRC) signaling. In this case, the configuration 140 may be specific to the UE 110. Alternatively, the configuration 140 may be specific to a cell the UE 110 is associated with. In an embodiment, the configuration 140 may be broadcast via a system information block (SIB) to a cell the UE 110 is associated with.

In the NTN scenario, because the satellite movement may be predictable, large scale channel condition between the satellite in which the network device 120 is located and the UE 110 over time can be forecasted to a large extent. The channel condition may be in terms of pathloss, e.g. free space pathloss (FSPL). Thus, for example, if the channel conditions of the UEs in the cell are identical or similar because e.g. the coverage area of the satellite is small or the satellite orbit is across the center area of the cell, the configuration 140 may be specific to the cell and thus the UEs in the cell may share the configuration 140. If the channel conditions of the UEs in the cell are different because e.g. the coverage area of the satellite is large or the satellite orbit is across the edge area of the cell, the configuration 140 may be specific to individual UE in the cell. Alternatively, if the channel conditions of some UEs in the cell are identical or similar and the channel conditions of some other UEs in the cell are different, the configuration 140 may be shared by the UEs with identical or similar channel conditions and other configuration 140 may be specific to individual UE of the other UEs. Alternatively or additionally, the configuration 140 may be different for UE(s) at the edge area of the satellite beam and UE(s) at the center area of the satellite beam and UE(s), if the beam size is large enough to result in different channel conditions at the edge area and the center area.

In an embodiment, the at least one parameter 144 may comprise at least one duration value. A duration value of the at least one duration value may be a time of validity for a corresponding repetition factor in the repetition factor set 142, and after the time of validity indicated by the duration value, another repetition factor may be used by the UE 110. In other words, the repetition factor for the configured UL channel resources may be time-varying, and the UE 110 may change the repetition factor automatically at the expiration of the time of validity.

The at least one duration value may be in terms of second, millisecond, slot, system frame number (SFN), etc. to indicate a period of time. In an embodiment, the at least one duration value may be one duration value corresponding to the repetition factor set 142. For example, one or more repetition factors in the repetition factor set 142 may have the identical validity of time indicated by the duration value. Alternatively, the at least one duration value may be a vector of duration values associated with the repetition factor set 142. For example, one or more repetition factors in the repetition factor set 142 may have different duration values.

The duration vector may be e.g. configured as [5, 10, 25] s, ms, slots, subframes, or frames, etc. or as [1, 2, 5]*multiplication factor (5 s, ms, slots, subframes, or frames, etc.).

In an embodiment, the repetition factor set 142 may comprise a single repetition factor. For example, the network device 120 may configure one repetition factor for the UE 110 and configure another repetition factor for the UE 110 e.g. when the channel condition changes or when the corresponding duration value elapses.

In an embodiment, the repetition factor set 142 may be a vector of repetition factors. For example, the repetition vector may include repetition factors corresponding to duration values, respectively. If the duration values in the duration vector are mapped one-to-one to the repetition factors in the repetition vector, an index t may indicate the position in respective vectors and thus the duration value and the repetition factor may be determined if the index t is determined.

Receiving the configuration 140 from the network device 120, in an operation 150, the UE 110 may determine the repetition factor from the repetition factor set 142 based on the at least one parameter 144 and then in an operation 160 the UE 110 may perform the transmission of the UL channel according to the determined repetition factor.

In an embodiment, the at least one parameter 144 may comprise a mapping between the repetition factor set and at least one distance value between the UE 110 and the network device 120, and the repetition factor may be determined based on a distance value between the UE 110 and the network device 120. The distance value between the UE 110 and the network device 120 may be measured by either the UE 110 or the network device 120, and the UE 110 may receive the distance value from the network device 120 if the distance value is measured by the network device 120. The FSPL may be forecast based on the distance value, and thus the repetition factor set 142 may be configured such that a proper repetition factor may correspond to a range of distance value. Thus different distance value ranges may be mapped to the repetition vector as well as the duration vector. For example, the repetition factor of 4 may be configured for the distance value from 600 km to 1000 km, the repetition factor of 8 may be configured for the distance value from 1000 km to 1400 km, and the repetition factor of 12 may be configured for the distance value from 1400 km to 1800 km, etc. Such an example mapping may be included in the at least one parameter 144 and transmitted from the network device 120 to the UE 110. Therefore, based on the distance value between the UE 110 and the network device 120, the UE 110 may determine the corresponding repetition factor. It may be appreciated that as one option, in this manner the at least one duration value may not be necessary. Alternatively, if the repetition factor has a corresponding duration value, the UE 110 may determine the next repetition factor at the expiration of the duration value. If the distance value is still in the identical distance value range, the next repetition factor may be identical to the preceding repetition factor.

For example, assuming the repetition vector is [3, 6, 9], and an index t=[0, 1, 2] indicates the position in the respective vector and corresponds to the respective distance value ranges, the UE 110 may determine the index t based on the distance value. For example, if the distance value falls in the range from 1400 km to 1800 km, and in this case t=2, the UE 110 may determine the repetition factor of 9. If the at least one parameter 144 comprises a duration vector=[4, 8, 16] one-to-one mapping to the repetition vector, the UE 110 may also determine the duration value for the repetition factor of 9 to be 16 s, ms, slots, subframes, or frames, etc. At the expiration of the 16 s, ms, slots, subframes, or frames, etc., the UE 110 may measure the distance value again, and determine the index t which may be the same or different compared to previous measurement.

In an embodiment, the at least one parameter 144 may comprise a mapping between the repetition factor set and at least one elevation angle value of the network device 120 relative to the UE 110, and the repetition factor may be determined based on an elevation angle value, indicted as Φ, of the network device 120 relative to the UE 110. The elevation angle value of the network device 120 relative to the UE 110 may be measured by e.g. the network device 120 based on the location of the UE 110, and the UE 110 may receive the elevation angle value from the network device 120. The FSPL may be forecast based on the elevation angle value, and thus the repetition factor set 142 may be configured such that a proper repetition factor may correspond to a range of elevation angle values. Therefore, based on the elevation angle value of the network device 120 relative to the UE 110, the UE 110 may determine the corresponding repetition factor. It may be appreciated that as one option, in this manner the at least one duration value may not be necessary. Alternatively, if the repetition factor has a corresponding duration value, the UE 110 may determine the next repetition factor at the expiration of the duration value. If the elevation angle value is still in the identical elevation angle value range, the next repetition factor may be identical to the preceding repetition factor.

The corresponding relation among the elevation angle value ranges, the repetition factors and the duration values may be configured as for example the following Table 1.

TABLE 1

| Elevation angle | | Duration | |
|---|---|---|---|
| value range | | value | Repetition |
| (degree) | Index t | (second) | factor |
| 10 < Φ < 20 | 0 | 25 | 12 |
| 21 < Φ < 40 | 1 | 10 | 8 |
| 41 < Φ < 75 | 2 | 5 | 4 |

In the example shown in the Table 1, the repetition vector is [12, 8, 4]. If the elevation angle value is e.g. 30 degree falling in the elevation angle value range of 21 to 40 degree, then t=1, and thus the UE 110 may determine the repetition factor of 8. If the at least one parameter 144 comprises a duration vector=[25, 10, 5] one-to-one mapping to the repetition vector, the UE 110 may also determine the duration value for the repetition factor of 8 to be 10 s. Such an example mapping may be included in the at least one parameter 144 and transmitted from the network device 120 to the UE 110.

A reason for such a configuration 140 may be a fact that generally the channel condition at high elevation angle value would vary faster than that at low elevation angle value, and it may be appreciated that the values in the Table 1 are examples.

In an embodiment, the at least one parameter 144 may further comprise an initial timing, and the repetition factor may be determined based on the initial timing, a current timing and the at least one duration value. The initial timing may be the timing when the satellite starts covering a certain area of a cell, for example, when the satellite is at horizon of the UE 110.

In an embodiment, the initial timing and the current timing may be in terms of SFN. In this case, the initial timing may be indicated as initial SFN, denoted as SFNᵢₙᵢₜ and the current timing may be the current SFN denoted as SFN₀, and the UE 110 may start counting the SFN from the initial SFN. So in this embodiment, the repetition factor may be determined based on the SFN level relative to the at least one duration value.

In a case where the at least one duration value is one duration value, denoted as d, and the repetition factors in the repetition factor set 142 correspond to respective index t=0, 1, 2, . . . , the index t for the current SFN may be calculated as the formula (1)

$$t = ⌊ \frac{{SFN}_{0} - {SFN}_{init}}{d} ⌋ \qquad ( 1 )$$

So, depending on how many duration values have elapsed since the initial SFN, the index t may be determined.

Then, the corresponding repetition factor for the UE 110 to transmit the UL channel at the current SFN may be determined though the formula (2).

$${N}_{rep} = {N}_{rep}^{vec} ( t ) \qquad ( 2 )$$

where Nᵣₑₚ indicates the determined repetition factor for the UL channel to be transmitted in SFN₀, Nᵣₑₚ^{vec} indicates the configured repetition factor set, and Nᵣₑₚ^{vec}(t) indicates the repetition factor at the position indicated by the index t.

In a case where the at least one duration value is a duration vector of duration values corresponding to the repetition factors in the repetition vector Nᵣₑₚ^{vec}, respectively, the duration value may be denoted as dₜ, and the repetition factor may be denoted as Nᵣₑₚ^{vec}(t) where t=1, 2, . . . , indicates the index of the duration value in the duration vector and the index of the repetition factor in the repetition vector, the index t for the current SFN may be calculated as the formulas (3) and (4)

$$t = 1 , if ⌊ \frac{{SFN}_{0} - {SFN}_{init}}{{d}_{1}} ⌋ = 0 \qquad ( 3 )$$

$$t = N , if ⌊ \frac{{SFN}_{0} - ( {SFN}_{init} + {\sum }_{i = 1}^{N - 1} di )}{{d}_{N}} ⌋ = 0 \qquad ( 4 )$$

where N is the number of repetition factors in Nᵣₑₚ^{vec} and also the number of duration values and is equal to or more than 2.

Then, the corresponding repetition factor Nᵣₑₚ^{vec}(t) may be determined for the UE 110 to transmit the UL channel at the current SNF.

For example, assuming the UE 110 is configured with two repetition factors (Nᵣₑₚ^{vec}(1), Nᵣₑₚ^{vec}(2)) and two different durations (d₁=100, d₂=20 frames), and the initial SFN=0. At SFN₀=87, according to the formula (3),

$$⌊ \frac{{SFN}_{0} - {SFN}_{init}}{{d}_{1}} ⌋ = 0 ,$$

so t=1 and thus the UE 110 may transmit the UL channel according to the repetition factor Nᵣₑₚ^{vec}(1) at SFN₀=87. At SFN₀=110, the formula (4) would be

$$⌊ \frac{{SFN}_{0} - ( {SFN}_{init} + {d}_{1} )}{{d}_{2}} ⌋ = ⌊ \frac{110 - ( 100 )}{20} ⌋ = 0 ,$$

so t=2 and thus the UE 110 may transmit the UL channel according to the repetition factor Nᵣₑₚ^{vec}(2) at SFN₀=110.

The UL channel to which the example embodiments may be implemented may be at least one of the following: PUCCH, physical uplink shared channel (PUSCH), physical random access channel (PRACH), and sounding reference signal (SRS).

According to example embodiments of the present disclosure, the network side may determine a configuration for transmission of the UL channel, by which the repetition factor for configured UL channel resources may be dynamically adjusted, therefore the signaling overhead may be reduced. Moreover, the configuration for transmission of the UL channel may be transmitted based on the RRC configuration and/or SIB broadcast signaling, and thus downlink control information (DCI) signaling may be saved.

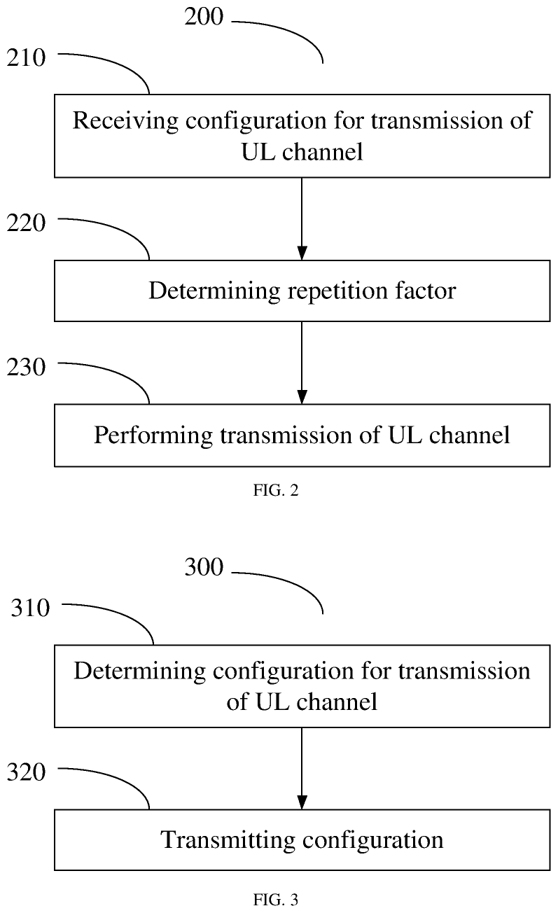

FIG. 2 shows a flow chart illustrating an example method 200 for dynamically adjusting repetition factor according to the example embodiments of the present disclosure. The example method 200 may be performed for example at a terminal device such as the UE 110.

Referring to the FIG. 2, the example method 200 may include an operation 210 of receiving, from a network device, a configuration for transmission of an UL channel, the configuration may comprise a repetition factor set and at least one parameter for determining a repetition factor from the repetition factor set; an operation 220 of determining the repetition factor from the repetition factor set based on the at least one parameter; and performing the transmission of the UL channel according to the determined repetition factor.

Details of the operation 210 have been described in the above descriptions with respect to at least the configuration 140, the repetition factor set 142 and the at least one parameter 144, and repetitive descriptions thereof are omitted here.

Details of the operation 220 have been described in the above descriptions with respect to at least the operation 150, and repetitive descriptions thereof are omitted here.

Details of the operation 230 have been described in the above descriptions with respect to at least the operation 160, and repetitive descriptions thereof are omitted here.

In an embodiment, the at least one parameter may comprise at least one duration value. The more details have been described in the above descriptions with respect to at least the at least one parameter 144, and repetitive descriptions thereof are omitted here.

In an embodiment, the at least one duration value may be in terms of SFN. The more details have been described in the above descriptions with respect to at least the at least one duration value, and repetitive descriptions thereof are omitted here.

In an embodiment, the at least one duration value may be one duration value corresponding to the repetition factor set. The more details have been described in the above descriptions with respect to at least the at least one duration value, and repetitive descriptions thereof are omitted here.

In an embodiment, the at least one duration value may be a vector of duration values associated with the repetition factor set. The more details have been described in the above descriptions with respect to at least the at least one duration value, and repetitive descriptions thereof are omitted here.

In an embodiment, the repetition factor set may be a vector of repetition factors. The more details have been described in the above descriptions with respect to at least the repetition factor set 142, and repetitive descriptions thereof are omitted here.

In an embodiment, the repetition factor set may comprise a single repetition factor. The more details have been described in the above descriptions with respect to at least the repetition factor set 142, and repetitive descriptions thereof are omitted here.

In an embodiment, the at least one parameter may further comprise an initial timing, and the repetition factor may be determined based on the initial timing, a current timing and the at least one duration value. The more details have been described in the above descriptions with respect to at least the initial timing and the operation 150, and repetitive descriptions thereof are omitted here.

In an embodiment, the initial timing and the current timing may be in terms of SFN. The more details have been described in the above descriptions with respect to at least the SFNᵢₙᵢₜ and the SFN₀, and repetitive descriptions thereof are omitted here.

In an embodiment, the at least one parameter may comprise a mapping between the repetition factor set and at least one distance value between the terminal device and the network device, and the repetition factor may be determined based on a distance value between the terminal device and the network device. The more details have been described in the above descriptions with respect to at least the at least one parameter 144 and the operation 150, and repetitive descriptions thereof are omitted here.

In an embodiment, the at least one parameter may comprise a mapping between the repetition factor set and at least one elevation angle value of the network device relative to the terminal device, and the repetition factor may be determined based on an elevation angle value of the network device relative to the terminal device. The more details have been described in the above descriptions with respect to at least the at least one parameter 144 and the operation 150, and repetitive descriptions thereof are omitted here.

In an embodiment, the configuration may be received via a RRC signaling or a SIB. The more details have been described in the above descriptions with respect to at least the configuration 140, and repetitive descriptions thereof are omitted here.

In an embodiment, the configuration may be specific to the terminal device or specific to a cell the terminal device is associated with. The more details have been described in the above descriptions with respect to at least the configuration 140, and repetitive descriptions thereof are omitted here.

In an embodiment, the UL channel may be at least one of the following: PUCCH, PUSCH, PRACH, and SRS.

FIG. 3 shows a flow chart illustrating an example method 300 for dynamically adjusting repetition factor according to the example embodiments of the present disclosure. The example method 300 may be performed for example at a network device such as the network device 120.

Referring to the FIG. 3, the example method 300 may include an operation 310 of determining a configuration for transmission of an UL channel, the configuration may comprise a repetition factor set and at least one parameter for determining a repetition factor from the repetition factor set; and an operation 320 of transmitting, to a terminal device, the configuration.

Details of the operation 310 have been described in the above descriptions with respect to at least the operation 130, the configuration 140, the repetition factor set 142 and the at least one parameter 144, and repetitive descriptions thereof are omitted here.

Details of the operation 320 have been described in the above descriptions with respect to at least the configuration 140, the repetition factor set 142, and repetitive descriptions thereof are omitted here.

In an embodiment, the at least one parameter may comprise at least one duration value. The more details have been described in the above descriptions with respect to at least the at least one parameter 144, and repetitive descriptions thereof are omitted here.

In an embodiment, the at least one duration value may be in terms of SFN. The more details have been described in the above descriptions with respect to at least the at least one duration value, and repetitive descriptions thereof are omitted here.

In an embodiment, the at least one duration value may be one duration value corresponding to the repetition factor set. The more details have been described in the above descriptions with respect to at least the at least one duration value, and repetitive descriptions thereof are omitted here.

In an embodiment, the at least one duration value may be a vector of duration values associated with the repetition factor set. The more details have been described in the above descriptions with respect to at least the at least one duration value, and repetitive descriptions thereof are omitted here.

In an embodiment, the repetition factor set may be a vector of repetition factors. The more details have been described in the above descriptions with respect to at least the repetition factor set 142, and repetitive descriptions thereof are omitted here.

In an embodiment, the repetition factor set may comprise a single repetition factor. The more details have been described in the above descriptions with respect to at least the repetition factor set 142, and repetitive descriptions thereof are omitted here.

In an embodiment, the at least one parameter may further comprise an initial timing in terms of system frame number. The more details have been described in the above descriptions with respect to at least the initial timing and the SFNᵢₙᵢₜ, and repetitive descriptions thereof are omitted here.

In an embodiment, the at least one parameter may comprise a mapping between the repetition factor set and at least one distance value between the terminal device and the network device. The more details have been described in the above descriptions with respect to at least the at least one parameter 144, and repetitive descriptions thereof are omitted here.

In an embodiment, the at least one parameter may comprise a mapping between the repetition factor set and at least one elevation angle value of the network device relative to the terminal device. The more details have been described in the above descriptions with respect to at least the at least one parameter 144, and repetitive descriptions thereof are omitted here.

In an embodiment, the configuration may be transmitted via a RRC signaling or a SIB. The more details have been described in the above descriptions with respect to at least the configuration 140, and repetitive descriptions thereof are omitted here.

In an embodiment, the configuration may be specific to the terminal device or specific to a cell the terminal device is associated with. The more details have been described in the above descriptions with respect to at least the configuration 140, and repetitive descriptions thereof are omitted here.

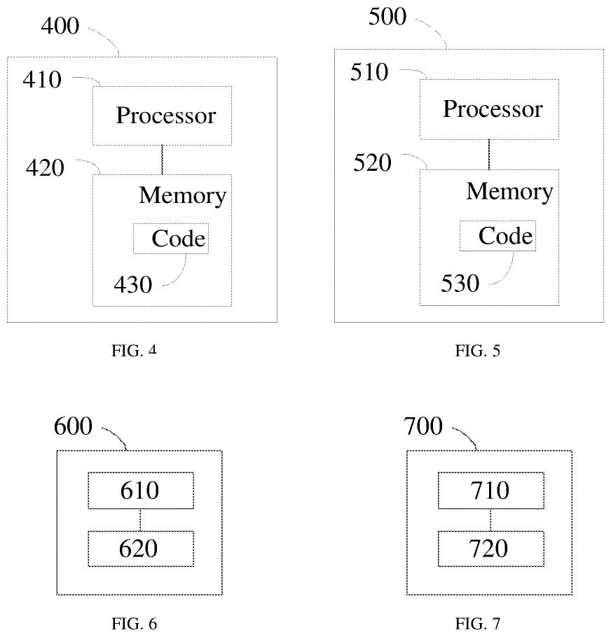

FIG. 4 shows a block diagram illustrating an example device 400 for dynamically adjusting repetition factor according to the example embodiments of the present disclosure. The device, for example, may be at least part of a terminal device such as the UE 110 in the above examples.

As shown in the FIG. 4, the example device 400 may include at least one processor 410 and at least one memory 420 that may include computer program code 430. The at least one memory 420 and the computer program code 430 may be configured to, with the at least one processor 410, cause the device 400 at least to perform the example method 400 described above.

In various example embodiments, the at least one processor 410 in the example device 400 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 410 may also include at least one other circuitry or element not shown in the FIG. 4.

In various example embodiments, the at least one memory 420 in the example device 400 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 420 may include, but are not limited to, an electric, a magnetic, an optical, an electromagnetic, an infrared, or a semiconductor system, apparatus, or device or any combination of the above.

Further, in various example embodiments, the example device 400 may also include at least one other circuitry, element, and interface, for example at least one I/O interface, at least one antenna element, and the like.

In various example embodiments, the circuitries, parts, elements, and interfaces in the example device 400, including the at least one processor 410 and the at least one memory 420, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 400.

FIG. 5 shows a block diagram illustrating an example device 500 for dynamically adjusting repetition factor according to the example embodiments of the present disclosure. The device, for example, may be at least part of a network device such as the network device 120 in the above examples.

As shown in the FIG. 5, the example device 500 may include at least one processor 510 and at least one memory 520 that may include computer program code 530. The at least one memory 520 and the computer program code 530 may be configured to, with the at least one processor 510, cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 120 is not limited to the above example device 500.

FIG. 6 shows a block diagram illustrating an example apparatus 600 for dynamically adjusting repetition factor according to the example embodiments of the present disclosure. The apparatus, for example, may be at least part of a terminal device such as the UE 110 in the above examples.

As shown in FIG. 6, the example apparatus 600 may include means 610 for performing the operation 210 of the example method 200, means 620 for performing the operation 220 of the example method 200, and means 630 for performing the operation 230 of the example method 200. In one or more another example embodiments, at least one I/O interface, at least one antenna element, and the like may also be included in the example apparatus 600.

In some example embodiments, examples of means in the example apparatus 600 may include circuitries. For example, an example of means 610 may include a circuitry configured to perform the operation 210 of the example method 200, an example of means 620 may include a circuitry configured to perform the operation 220 of the example method 200, and an example of means 630 may include a circuitry configured to perform the operation 230 of the example method 200. In some example embodiments, examples of means may also include software modules and any other suitable function entities.

FIG. 7 shows a block diagram illustrating an example apparatus 700 for dynamically adjusting repetition factor according to the example embodiments of the present disclosure. The apparatus, for example, may be at least part of a network device such as the network device 120 in the above examples.

As shown in FIG. 7, the example apparatus 700 may include means 710 for performing the operation 310 of the example method 300, and means 720 for performing the operation 320 of the example method 300. In one or more another example embodiments, at least one I/O interface, at least one antenna element, and the like may also be included in the example apparatus 700.

In some example embodiments, examples of means in the example apparatus 700 may include circuitries. For example, an example of means 710 may include a circuitry configured to perform the operation 310 of the example method 300, and an example of means 720 may include a circuitry configured to perform the operation 320 of the example method 300. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
BS base station
CSI channel state information
DCI downlink control information
FSPL free space pathloss
NTN non-terrestrial network
PRACH physical random access channel
PUCCH physical uplink control channel
PUSCH physical uplink shared channel
RRC radio resource control
SFN system frame number
SIB system information block
SRS sounding reference signal
TN terrestrial network
UCI uplink control information
UE user equipment
UL uplink

1. A terminal device, comprising:
at least one processor; and
at least one memory comprising computer program code, the at least one memory and the computer program code being configured to, with the at least one processor, cause the terminal device to perform:
receiving, from a network device, a configuration for transmission of an uplink channel, the configuration comprising a repetition factor set and at least one parameter for determining a repetition factor from the repetition factor set;
determining the repetition factor from the repetition factor set based on the at least one parameter; and
performing the transmission of the uplink channel according to the determined repetition factor.

2. The terminal device of claim 1, wherein the at least one parameter comprises at least one duration value.

3. The terminal device of claim 2, wherein the at least one duration value is in terms of system frame number.

4. The terminal device of claim 2, wherein the at least one duration value is one duration value corresponding to the repetition factor set.

5. The terminal device of claim 2, wherein the at least one duration value is a vector of duration values associated with the repetition factor set.

6. The terminal device of claim 1, wherein the repetition factor set is a vector of repetition factors.

7. The terminal device of claim 1, wherein the repetition factor set comprises a single repetition factor.

8. The terminal device of claim 2, wherein the at least one parameter further comprises an initial timing, and the repetition factor is determined based on the initial timing, a current timing and the at least one duration value.

9. The terminal device of claim 2, wherein the at least one parameter further comprises an initial timing, and the repetition factor is determined based on the initial timing, a current timing and the at least one duration value; and
wherein the initial timing and the current timing are in terms of system frame number.

10. The terminal device of claim 1, wherein the at least one parameter comprises a mapping between the repetition factor set and at least one distance value between the terminal device and the network device, and the repetition factor is determined based on a distance value between the terminal device and the network device.

11. The terminal device of claim 1, wherein the at least one parameter comprises a mapping between the repetition factor set and at least one elevation angle value of the network device relative to the terminal device, and the repetition factor is determined based on an elevation angle value of the network device relative to the terminal device.

12. The terminal device of claim 1, wherein the configuration is received via a radio resource control signaling or a system information block.

13. The terminal device of claim 1, wherein the configuration is specific to the terminal device or specific to a cell the terminal device is associated with.

14. The terminal device of claim 1, wherein the uplink channel is at least one of the following: physical uplink control channel, physical uplink shared channel, physical random access channel, and sounding reference signal.

15. A network device, comprising:
at least one processor; and
at least one memory comprising computer program code, the at least one memory and the computer program code being configured to, with the at least one processor, cause the network device to perform:
determining a configuration for transmission of an uplink channel, the configuration comprising a repetition factor set and at least one parameter for determining a repetition factor from the repetition factor set; and
transmitting, to a terminal device, the configuration.

16. The network device of claim 15, wherein the at least one parameter comprises at least one duration value.

17. The network device of claim 16, wherein the at least one duration value is in terms of system frame number.

18. The network device of claim 16, wherein the at least one duration value is one duration value corresponding to the repetition factor set.

19. The network device of claim 16, wherein the at least one duration value is a vector of duration values associated with the repetition factor set.

20. The network device of claim 15, wherein the repetition factor set is a vector of repetition factors.

21-56. (canceled)
